(19) United States
(12) Patent Application Publication
(10) Pub. No.: US 2012/0226473 A1
(43) Pub. Date: Sep. 6, 2012

(54) DEVICE FOR DETERMINING THE WEIGHT OF AN OBJECT

(76) Inventors: Gérard Claverie, Blanquefort (FR); Jean-Pierre Fortin, Merignac (FR); Bernard Gutfrind, Gradignan (FR)

(21) Appl. No.: 13/497,584

(22) PCT Filed: Nov. 3, 2010
(86) PCT No.: PCT/FR10/52356

§ 371 Date: Mar. 22, 2012

(30) Foreign Application Priority Data
Nov. 6, 2009 (FR) 0957871

(51) Int. Cl. G06F 15/00

(52) U.S. Cl. 702/173

(57) ABSTRACT

The invention relates to a device for determining the weight of an object, including at least one elongate object holder (5), arranged on at least a first and second hearing, and a processing means suitable for calculating the weight of the object, regardless of the position of the object on the object holder (5) between a first straight measurement section (α) located on the side of the first bearing and a second straight measurement section (β) located on the side of the second bearing, characterised in that the processing means is suitable for determining the weight of the object by adding or subtracting two values of a physical parameter selected among the heading moment and the shearing strain, said values being added together if the physical parameter is the bending moment and subtracted if the physical parameter is the shearing strain, the distance between the first measurement section (α) and the first bearing being equal to the distance between the second measurement section (β) and the second bearing if the physical parameter is the bending moment, said values being determined at the measurement sections (α, β) by means of deformation guages arranged two-by-two symmetrically relative to the neutral plane of the object holder (5).

The subject of the present invention is a device for determining the weight of an object. The device according to the invention makes it possible to determine simply and precisely the weight of moving or stationary objects.

It is known practice to measure rolling loads in a static manner with the aid of weighbridges or equivalent systems.

These systems are particularly costly. They may in particular require special routes for gaining access to the weighing areas. The drawback of this is that it causes waste of time associated with the necessities of immobilizing the loads on the weighing area while weighing takes place, and expenditure on personnel assigned to this type of measurement.

The object of the invention is to remedy these drawbacks.

It proposes a device making it possible to measure the weight of objects precisely and economically, in particular the weight of moving objects such as vehicles that can run at high speed and notably at a cruising speed.

The subject of the invention is therefore a device for determining the weight of an object, comprising at least one object support of elongate shape placed on at least a first and a second bearing surface, and processing means capable of computing the weight of the object, irrespective of the position of the object on the object support between a first measurement cross section situated on the side of the first bearing surface and a second measurement cross section situated on the side of the second bearing surface.

According to the invention, the processing means are, capable of determining the weight of the object based on the addition or the subtraction of two values of a physical parameter chosen between the bending moment and the shearing force, the said values being added together if the physical parameter is the bending moment or subtracted if the physical parameter is the shearing force, the distance between the first measurement cross section and the first bearing surface being equal to the distance between the second measurement cross section and the second bearing surface if the physical parameter is the bending moment, the said values being determined at the measurement cross sections using distortion gauges, the distortion gauges being placed in twos symmetrically relative to the neutral plane of the object support.

By virtue of the fact that the addition or subtraction of the values of the physical parameter gives a result proportional to the weight of the object, the assembly makes it possible to easily determine the weight of the object, with the aid of a calibration with reference weights.

The neutral plane is the plane that is situated inside the object support and that is the surface formed by the fibres of the object support which sustain neither shortening nor lengthening and retain a constant length. In the bending phenomena, the shearing stresses due to the shearing force are maximal at the neutral plane and the bending (tension, compression) stresses are maximal in absolute values on the upper and lower faces of the object support, the shearing stresses being zero at this level.

The use of the distortion gauges also makes it possible to obtain particularly precise measurements.

A distortion gauge is a component that makes it possible to monitor the distortions of materials subjected to stresses, by means of the variations in resistance of an electrical conductor.

Each object support is advantageously a beam.

The specific assembly of the distortion gauges into a complete Wheatstone bridge makes it possible to obtain an output electrical signal from the bridge that is proportional to the weight of the object. The distortion gauges may therefore be connected together to form a Wheatstone bridge, so that the potential difference at the output of the bridge is proportional to the weight of the object.

In a first embodiment, the physical parameter is the bending moment. In this case, the distance between the first measurement cross section and the first bearing surface is equal to the distance between the second measurement cross section and the second bearing surface.

For this first embodiment, the distortion gauges advantageously comprise, at each measurement cross section, two upper gauges placed lengthwise above the neutral plane, on either side of the longitudinal vertical plane of symmetry of the object support, and two lower gauges placed lengthwise beneath the neutral plane, the lower gauges being the symmetrics of the upper gauges relative to the neutral plane.

The upper gauges are preferably symmetrical relative to the longitudinal vertical plane of symmetry of the object support and the lower gauges are preferably symmetrical relative to the longitudinal vertical plane of symmetry of the object support.

In a second embodiment, the physical parameter is the shearing force. In this case, the distortion gauges advantageously comprise, at each measurement cross section, two assemblies of two gauges placed on the neutral plane, on either side of the longitudinal vertical plane of symmetry of the object support, each assembly of gauges comprising two gauges that are orthogonal and inclined at 45° relative to the neutral plane.

The two assemblies of two gauges on each measurement cross section are preferably symmetrical relative to the longitudinal vertical plane of symmetry of the object support.

For each physical parameter, the distortion gauges of the measurement cross sections are advantageously connected to form a Wheatstone bridge so as to determine the weight of the object based on a signal that is unique and specific to each physical parameter.

The device according to the invention may comprise at least two object supports. This variant, which may be used with the first or the second embodiment, is particularly suitable for measuring the weight of objects moving at high speed over several object supports, such as for example motor vehicles.

In general, the object supports may be substantially parallel, and preferably parallel.

The device may belong to a pre-existing moving or stationary structure. For example, it is possible to envisage measuring the weight of the object by fitting extensiometer gauges to the cross-beam of a travelling crane provided that this beam fulfils the processing conditions defined above. Similarly, a tipping lorry or a cement-mixer lorry could be fitted with an on-board system of the same principle if there is in its structure a beam fulfilling the conditions of the invention. In general, the device may be fitted to any type of pre-existing structure if there is in this structure one or more beams fulfilling the said conditions.

A further subject of the invention is the use of a device described above for determining the weight of a moving object.

Finally, it has as subject the use of a device described above for determining the weight of several objects supported simultaneously by the object support.

Other features and advantages of the present invention will appear more clearly on reading the following description given as an illustrative and non-limiting example, and made with reference to the appended drawings in which:

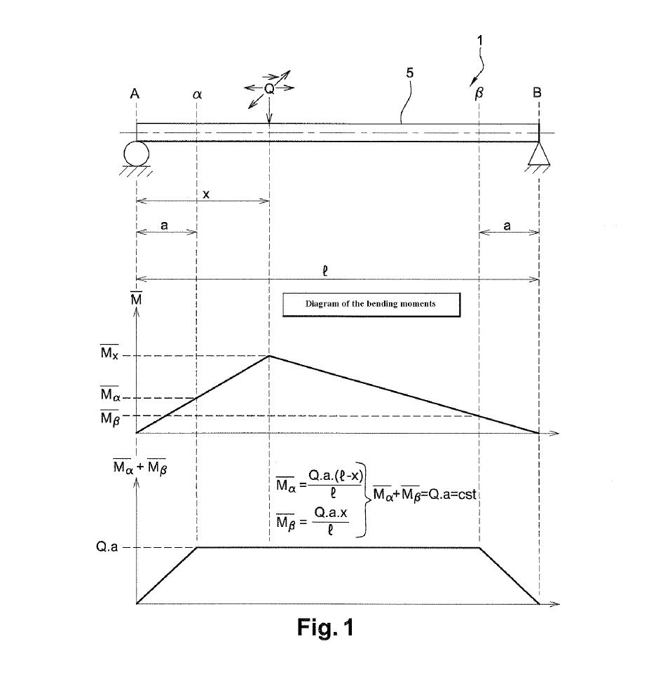

FIGS. 1 to 3 illustrate a first embodiment of a device for determining the weight of an object according to the invention,

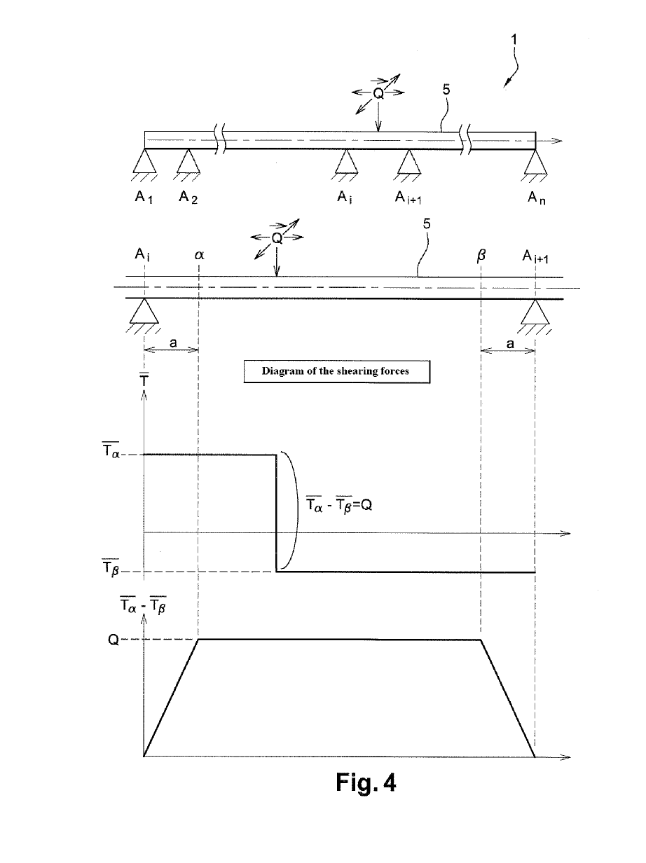

FIGS. 4 to 6 illustrate a second embodiment of a device for determining the weight of an object according to the invention,

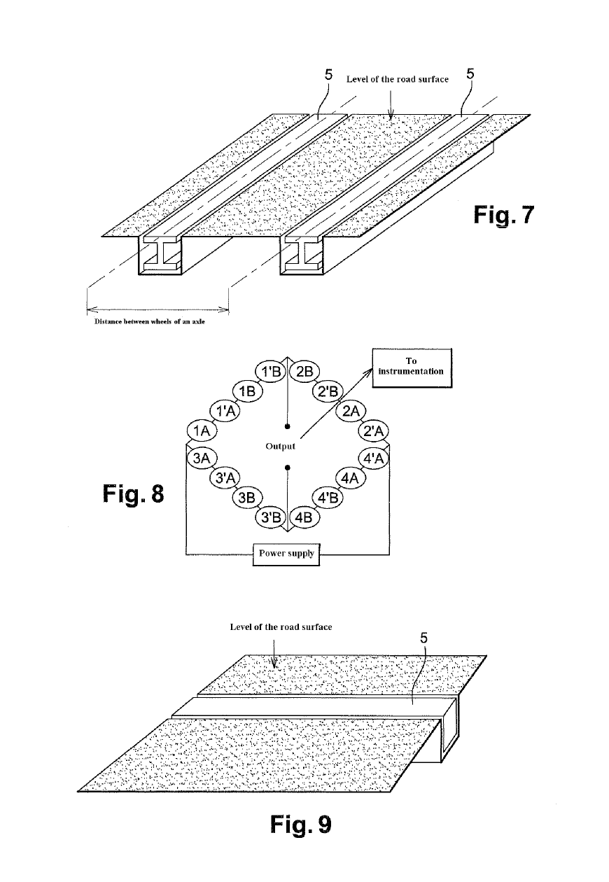

FIGS. 7 and 8 illustrate a preferred variant of the second embodiment, and

FIG. 9 illustrates a preferred variant of the first embodiment.

The device 1 for determining the weight of an object, as illustrated in FIG. 1, comprises a beam 5 of length l, fixed horizontally onto two bearing surfaces at each of its ends A and B.

Between the two bearing surfaces, two measurement cross sections α and β are chosen which are situated at an equal distance and preferably at a 25 short distance a from the bearing surfaces. An object of weight Q is situated on the beam 5, between the measurement cross sections α and β, at a distance x from the bearing surface situated at the end A.

The diagram of FIG. 1 shows that irrespective of the position x of the object between the cross sections α and β, the total of the bending moment Mα at α and of the bending moment Mβ at β is a constant equal to Qa, proportional to the weight of the object. The first embodiment of the invention uses this finding to determine the weight of the object.

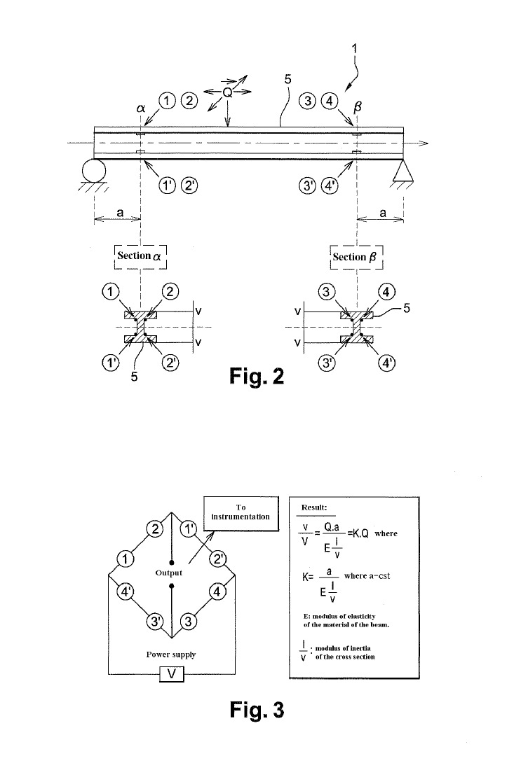

Accordingly, as illustrated in FIG. 2, the beam 5 is furnished, at the cross section α, with four lengthwise distortion gauges 1,2,1′,2′, with the same electrical resistance and placed in the lengthwise direction of the beam 5. Two gauges 1, 2 are placed above the neutral plane of the beam 5, so as to measure the compression of the beam 5 at α, while the two gauges 1′,2′ are placed beneath the neutrarplane, so as to measure the tension of the beam 5 at α. The gauges 1′,2′ are the symmetrics of the gauges 1,2 relative to the neutral plane. Thus, by using gauges on either side of the beam 5, the tortional effects are cancelled out. For a better accuracy of the measurements, the gauges 2,2′ are the symmetrics of the gauges 1,1′ relative to the longitudinal vertical plane of symmetry of the beam 5.

In the same manner, four distortion gauges 3,4,3′,4′ are placed at the cross section 3. The distortion gauges are placed in the same manner as the gauges 1,2,1′,2′ with respect to the beam 5.

A distortion gauge is based on the property that certain materials have wherein their conductivity varies when they are subjected to distortions. Since the variations of resistance are slight, it is preferable to make use of a Wheatstone bridge assembly as illustrated in FIG. 3.

Powered by a voltage source, the bridge has, in equilibrium, a zero output differential voltage, but the variation from one to the other of the resistances exhibits a non-zero output differential voltage. This assembly makes it possible to add the electrical resistance variations of the gauges in compression and in tension. Moreover, the complete bridge assembly compensates for the variations of the gauges as a function of the temperature, which means that the resultant measurement is not adversely affected.

Thus, the resistances of the gauges 1,2 and 3,4 on the one hand, and of the gauges 1′,2′ and 3′,4′ on the other hand, the signal of which is desired to be added together, are placed in opposition in the bridge. The output signal from the bridge is consequently proportional to the total of the bending moments Mα and Mβ, and is therefore proportional to the weight of the object. The weight of the object can then be easily determined with the aid of a calibration.

In a second embodiment, as illustrated in FIG. 4, the shearing force is used to determine the weight of the object. The elements identical to those of FIG. 1 bear the same references. In this embodiment, the beam 5 can be placed on several consecutive horizontal bearing surfaces referenced A₁, A₂, . . . , Aᵢ₊₁, . . . , Aₙ. The load Q moves between the cross sections α et β situated at an equal distance a from the bearing surfaces Aᵢ and Aᵢ₊₁. The shearing forces at α and β are respectively Tα and Tβ.

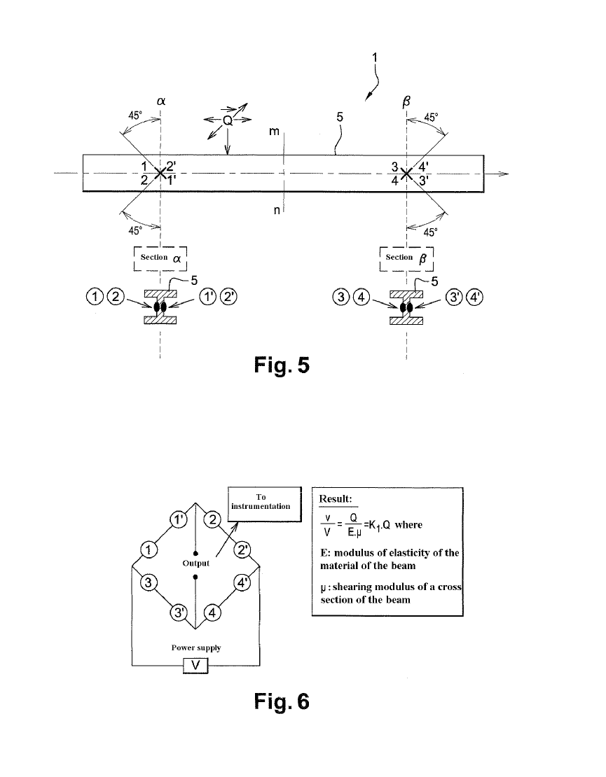

As illustrated in the diagrams of FIG. 4, it is demonstrated that Tα−Tβ=Q, when the load Q is situated between α and β. In the second embodiment, the weight of the object is therefore determined on the basis of the difference in the shearing forces measured at α and at β. It is known that a shearing stress that reflects the shearing force being applied on an elementary square can be determined by comparing the lengthenings of the diagonals of the square. Therefore strain gauges are placed along axes that are orthogonal and inclined at 45°, or substantially at 45°, relative to the horizontal, as illustrated in FIG. 5. Therefore, in the cross section α, use is made on one face of the beam 5 of two orthogonal gauges 1, 2 inclined at 45° relative to the horizontal, and, on the other face of the beam 5, use is also made of two orthogonal gauges 1′,2′ inclined at 45° relative to the neutral plane. The gauges 1,2,1′2′ are centred on the neutral plane of the beam 5. Moreover, the gauges 1′,2′ are advantageously the symmetrics of the gauges 1,2 relative to the longitudinal vertical plane of symmetry of the beam 5. Gauges are therefore used on either side of the beam 5, which makes it possible to cancel out the tortional effects. The cross section β is fitted with gauges 3,4,3′,4′, in a manner identical to the cross section α.

There is no electrical contact between the gauges which cross mechanically. The gauges 1,2,1′,2′ and 3,4,3′,4′ are symmetrical relative to the vertical axis (mn). The gauges can be grouped into twos in an assembly called a rosette assembly.

The electrical assembly of the gauges is illustrated in FIG. 6. As for the first embodiment, a Wheatstone bridge is used. The difference is calculated between the shearing force measured at α and the shearing force measured at β. The resistances of the gauges 1,1′ and 3,3′ are thus adjacent so as to act in opposite directions. The same applies to the resistances of the gauges 2,2′ and 4,4′.

In general, the analogue differential signal output from the Wheatstone bridge is processed by instrumentation that polarizes the bridge, amplifies the analogue signal, makes an analogue-digital conversion and digitally filters the signal. A central processing unit then digitally processes the information and can store it in memory. It is therefore possible to record the values of the measurements and carry out all the processing necessary to exploit them depending on the desired final application, such as for example the display of the weight of a load or the total weight of several loads on a digital display. In this instance, the number of successive loads can be programmed. The measurement protocol can be produced by an operator or a non-specialist user. The operator selects the static weighing mode or dynamic weighing mode. In the case of static weighing, the weight of the load is displayed instantaneously, for example on the display. In the case of dynamic weighing, the operator programmes the number of successive loads, then he selects the cyclicality of the successive loads either manually with the aid of an “on or off” actuator, or automatically by triggering an “on or off” sensor, as the moving load passes. The operator begins measurement with the aid of an “on or off” actuator. When the weighing of the number of programmed loads is complete, the total weight is for example displayed.

In a variant of the second embodiment, as illustrated in FIG. 7, the device may comprise two rectangular beams 5 fitted with gauges according to FIG. 5. This variant is particularly suitable for measuring the weight of objects moving at high speed, such as vehicles. The two beams 5 are sunk into the road surface. The two bearing surfaces of each beam 5 are arranged at the bottom of the recesses. The width of each beam 5 is greater than the width of the wheel of the vehicle. The coupling of the resistances of the gauges of each beam 5 is illustrated in FIG. 8. The beams 5 may also be sunk into a platform out of the ground for the vehicle to pass at low speed. Although the use of the shearing force as a physical parameter is particularly suitable for measuring the weight of objects travelling at high speed, it is also possible to use the bending moment as a physical parameter.

In a variant of the first embodiment, as illustrated in FIG. 9, a beam 5 fitted with gauges according to FIG. 2 is sunk into the road surface. The two bearing surfaces of the beam 5 are arranged at the bottom of the recess. In this variant, the vehicle to be weighed, for example a heavy goods vehicle, travels at low speed and passes over the beam 5 perpendicularly to the longitudinal axis of the beam 5. It is also possible to envisage that the beam 5 is sunk into a platform out of the ground.

The device according to the invention therefore makes it possible to weigh vertical, static or mobile loads, such as for example moving loads. The mobile loads can move over one or more horizontal and parallel beams that rest on two or more bearing surfaces. The loads may move either lengthwise over one or more parallel beams, typically over two beams, or perpendicularly to a single beam. The loads that move longitudinally over one or more parallel beams can move at high speed. The device according to the invention is particularly suitable for detecting overloading of heavy goods vehicles and allows enhanced control of this detection.

The invention therefore makes it possible to dispense with the use of multiple sensors of the load cell type or piezoelectric sensors, the use of which involves high cost and often requires the processing of one analogue signal per load cell. By virtue of the device according to the invention, it is also possible to weigh moving loads at high speed with an accuracy of the order of 2%, while the high-speed weighing systems using piezoelectric sensors provide an accuracy of the order of only 20%. This is due to the fact that the beam itself forms the sensor with a constant signal over the whole length of measurement. The device allows multiple usages with various configurations using one or more weighing beams, but requiring only one signal to be processed.

1. Device for determining the weight of an object, comprising:
at least one object support of elongate shape placed on at least a first and a second bearing surface, and
processing means capable of computing the weight of the object, irrespective of the position of the object on the object support, between a first measurement cross section (α) situated on the side of the first bearing surface and a second measurement cross section (β) situated on the side of the second bearing surface,
wherein the processing means are capable of determining the weight of the object based on the addition or the subtraction of two values of a physical parameter selected between the bending moment and the shearing force, the said values being added together if the physical parameter is the bending moment or subtracted if the physical parameter is the shearing force, the distance (a) between the first measurement cross section (α) and the first bearing surface being equal to the distance (a) between the second measurement cross section (β) and the second bearing surface if the physical parameter is the bending moment, the said values being determined at the measurement cross sections (α,β) using distortion gauges placed in twos symmetrically relative to the neutral plane of the object support.

2. Device according to claim 1, wherein each object support is a beam.

3. Device according to claim 1, wherein the distortion gauges are connected together to form a Wheatstone bridge, so that the potential difference at the output of the bridge is proportional to the weight of the object.

4. Device according to one of claim 1, wherein the physical parameter is the bending moment.

5. Device according to claim 4, wherein the distortion gauges comprise, at each measurement cross section (α,β), two upper gauges placed lengthwise above the neutral plane, on either side of the longitudinal vertical plane of symmetry of the object support, and two lower gauges placed lengthwise beneath the neutral plane, the lower gauges being the symmetries of the upper gauges relative to the neutral plane.

6. Device according to claim 5, wherein the upper gauges are symmetrical relative to the longitudinal vertical plane of symmetry of the object support and in that the lower gauges are symmetrical relative to the longitudinal vertical plane of symmetry of the object support.

7. Device according to one of claim 1, wherein the physical parameter is the shearing force, and in that the distortion gauges comprise, at each measurement cross section (α,β), two assemblies of two gauges placed on the neutral plane, on either side of the longitudinal vertical plane of symmetry of the object support, each assembly of gauges comprising two gauges that are orthogonal and inclined at 45° relative to_{.}the neutral plane.

8. Device according to claim 7, wherein the two assemblies of two gauges are symmetrical relative to the longitudinal vertical plane of symmetry of the object support.

9. Device according to claim 3, wherein, for each physical parameter, the distortion gauges of the measurement cross sections (α,β) are connected to form a Wheatstone bridge so as to determine the weight of the object based on a signal that is unique and specific to each physical parameter.

10. Device according to one of claim 1, wherein said device comprises at least two object supports.

11. Device according to claim 10, wherein the object supports are substantially parallel.

12. Device according to one of claim 1, wherein said device is part of a pre-existing moving or stationary structure.

13. A method for determining the weight of a moving object, said method comprising the step of employing said device of claim 1.

14. A method for determining the weight of several objects supported simultaneously by the object support, said method comprising the step of employing said device of claim 1.
